(19) United States
(12) Patent Application Publication
(10) Pub. No.: US 2017/0234579 A1
(43) Pub. Date: Aug. 17, 2017

(54) A SOLAR COLLECTOR PANEL AND A METHOD FOR OPERATING A SOLAR COLLECTOR PANEL

(71) Applicant: Hans Jørgen Christensen, Hadsten (DK)

(72) Inventor: Hans Jørgen Christensen, Hadsten (DK)

(21) Appl. No.: 15/505,523

(22) PCT Filed: Aug. 14, 2015
(86) PCT No.: PCT/DK2015/050240

§ 371 Date: Feb. 21, 2017

(30) Foreign Application Priority Data
Aug. 18, 2014 (DK) PA 2014 70497

(51) Int. Cl. F24J 2/04; B01D 53/28; F24J 2/46; B01D 53/30; F24J 2/40; B01D 53/26

(52) U.S. Cl. CPC F24J 2/0483; F24J 2/40; B01D 53/261; F24J 2/4618; B01D 53/30; B01D 53/28; B01D 2253/106

(57) ABSTRACT

Disclosed is a solar collector panel (1) configured for collecting thermal energy by heating of air. The solar collector panel (1) comprises an air conduit (2) for guiding air through the panel (1) between an air inlet (3) and an air outlet (4) and the panel (1) comprises air flow means (5) arranged to generate an air flow through the air conduit (2) from the air inlet (3) to the air outlet (4). The panel (1) further comprises light absorbing means (6) arranged in or at the air conduit (2) to heat passing air and air drying means (7) arranged between the air inlet (3) and the light absorbing means (6), wherein the air drying means (7) is arranged to reduce the absolute humidity of passing air. A method for operating a solar collector panel (1) is also disclosed.

### BACKGROUND OF THE INVENTION

The invention relates to a solar collector panel configured for collecting thermal energy by heating of air. The solar collector panel comprises an air conduit for guiding air through the panel between an air inlet and an air outlet and the panel comprises air flow means arranged to generate an air flow through the air conduit from the air inlet to the air outlet.

The invention further relates to a method for operating a solar collector panel.

### DESCRIPTION OF THE RELATED ART

Solar collector panels where air is heated by the sun and transported around the panel by means of one or more fans powered by a solar cell is well known in the art. An example of such a panel may be found in the international patent application WO 2011/063810.

When such a solar collector panel is in operation the air traveling through the panel is heated which will result in a drop in the relative humidity of the air, where the relative humidity is the ratio of the partial pressure of water vapor existing in the air-water mixture to the saturation vapor pressure of water at the same temperature. But if the solar collector panel e.g. is used for heating or dehumidifying a cold part of a house—like a basement—when the humidity in the outside air is high, the temperature of the air being blown into house from the panel will typically drop inside the house—thus, reducing the relative humidity and increasing the risk of condensation inside the house. This is disadvantageous in that condensation can lead to rot, mould and other.

An object of the invention is therefore to provide for a cost-efficient technique for reducing the absolute humidity of the air exhausted from a solar collector panel.

### THE INVENTION

The invention provides for a solar collector panel configured for collecting thermal energy by heating of air. The solar collector panel comprises an air conduit for guiding air through the panel between an air inlet and an air outlet and the panel comprises air flow means arranged to generate an air flow through the air conduit from the air inlet to the air outlet. The panel further comprises light absorbing means arranged in or at the air conduit to heat passing air and air drying means arranged between the air inlet and the light absorbing means, wherein the air drying means is arranged to reduce the absolute humidity of passing air.

Integrating air drying means capable of reducing the absolute humidity of the air passing through the panel is advantageous in that the air exhausted by the panel not only will aid in heating the room to which the panel is connected by also aid in reducing the absolute humidity.

It should be noted that the term “air flow means” in this context should be interpreted as any kind of air flow generator suited for generating a flow of air through an air conduit, such as any kind of fan, pump, hybrid ventilation means or other.

It should also be noted that the term “light absorbing means” in this context should be interpreted as any kind of light absorber suited for absorbing sunlight and heat passing air, such as practically any kind of material capable of absorbing radiation from the sun and converting it to heat—i.e. any kind of felt material, metal, ceramic or other.

It should further be noted that the term “air drying means” in this context should be interpreted as any kind of air drying arrangement capable of reducing the absolute humidity of passing air, such as any kind of thermal condensation means, mechanical/refrigerative dehumidifiers, makeshift dehumidifiers, desiccant, ionic membrane dehumidifier or other.

Even further, it should be noted that the terms “air inlet” and “air outlet” refers to the direction of the air flow through these orifice's during normal operation of the solar collector panel—i.e. when the solar collector panel is used for heating up air before it is exhausted out through the air outlet to heat a building or similar.

In an aspect of the invention, said air drying means comprises a desiccant.

One of the greatest advantages of conventional solar collector panels is that they do not need to be connected to an external power source to function—which severely reduces installation cost and running cost. A desiccant is a hygroscopic substance that induces or sustains a state of dryness (desiccation) in its vicinity—i.e. desiccants are passive moisture absorbers such as silica gel, clay absorbers, activated charcoal, calcium chloride and others. This passive dehumidifying quality of the desiccant is advantageous in relation with solar collector panels in that the dehumidification process can run without need of a power source. Furthermore, desiccants are easy to install and they will bind the collected moisture so it more easily can be handled.

In an aspect of the invention, said solar collector panel comprises reversing means for at least occasionally reversing the air flow through said panel.

Providing the solar collector panel with reversing means is advantageous in that by reversing the air flow through the panel, the air will first be heated by the light absorbing means—so that the relative humidity of the air is reduced—before it is passed through the air drying means which will dry and dehumidify the air drying means. Thus, by occasionally reversing the air flow direction through the panel the moisture absorbent quality of the air drying means can be regenerated whereby the life and the applicability of the panel is increased.

In an aspect of the invention, said reversing means is at least a part of said air flow means.

Forming the reversing means as at least a part of the air flow means is advantageous, in that it provides for a simple and inexpensive design. E.g. if the air flow means is a fan it is possible to generate the reversed air flow simply by reversing the rotational direction of the fan.

In an aspect of the invention, said panel further comprises a reversed flow air inlet through which air is drawn when said air flow is reversed.

Drawing the air from a separate dedicated inlet when the air flow direction is reversed is advantageous in that it then is possible to provide this inlet with dedicated filters—which not necessarily would be suited for normal operation—and it is possible to draw this air from e.g. the surroundings instead of from the e.g. the room to which air is exhausted during normal operation—which could provide a better air quality, a warmer air or a more dry air.

In an aspect of the invention, said panel further comprises one or more humidity sensors.

The moisture absorbing quality of the air drying means is typically associated with the amount of moisture suspended in the air drying means. In other words the more saturated the air drying means are the poorer they work. It is therefore important to at least regularly somehow control or monitor the efficiency of the air drying means. It is therefore advantageous to provide the panel with one or more humidity sensors in that such sensors wold be able to directly or indirectly measure the efficiency of the air drying means so the e.g. the reversing means could be controlled in response to this. The efficiency of the air drying means could e.g. be measured by means of a humidity sensor placed on, at or in the air drying means to directly measure the humidity of the air drying means or a humidity sensor located at the air inlet and a humidity sensor located at the air outlet would be able to indirectly measure the humidity of the air drying means by comparing the measurements of the two sensors.

The measurement of the humidity could advantageously be combined with measurement of the temperature to calculate the absolute humidity, which gives an even better basis for controlling the system.

In an aspect of the invention, said panel comprises control means arranged to activate said reversing means on the basis of input from said one or more humidity sensors.

Hereby is achieved an advantageous embodiment of the invention.

In an aspect of the invention, said air drying means is arranged in a separate container in or on said solar collector panel.

If the air drying means for some reason needs to be exchanged, repaired or other it is advantageous to arrange the air drying means in a separate container.

In an aspect of the invention, said separate container is detachably connected to said solar collector panel.

Connecting the container detachably to the solar collector panel is advantageous in that the air drying means hereby easily can be removed and exchanged.

In an aspect of the invention, said air drying means further comprises air cleaning means.

Providing the air drying means with air cleaning means is advantageous in that the air hereby also can be cleaned while passing through the air drying means.

In an aspect of the invention, said air inlet is arranged separate from said air outlet.

In an aspect of the invention, said air drying means are arranged between said air inlet and said light absorbing means inside said solar collector panel.

Arranging the air drying means inside the solar collector panel is advantageous in that a more compact and space-efficient panel is hereby provided—making it easier to store, mount etc.

In an aspect of the invention, said air drying means are arranged parallel with or at least substantially parallel with said light absorbing means.

In an aspect of the invention, the effective area of said air drying means is equivalent to or at least substantially equivalent to the effective area of said light absorbing means.

Forming the air drying means so that they extend over a relatively large area—i.e. substantially the entire effective area of the solar collector panel—is advantageous in that it increases the efficiency and capacity of the air drying means and it enables that the air inlet can be formed with a large effective area—thus reducing air flow speed at the inlet.

In an aspect of the invention, said air drying means extends substantially along the entire back plate of said solar collector panel.

In an aspect of the invention, said solar collector panel comprises a transparent or translucent front plate.

The invention also provides for a method for operating a solar collector panel, said method comprising the steps of:
generating an air flow through air drying means of said solar collector panel to reduce the absolute humidity of the air passing through said air drying means, where after the air is led passed or through light absorbing means to heat said air, and
at least occasionally reversing the air flow direction so that the air is first led by said light absorbing means and then through said air drying means.

Reducing the absolute humidity of the air exhausted from the solar collector panel is advantageous in that this will increase the applicability of the solar collector panel since it can also or instead function as a dehumidifier.

But the absorbed humidity will build up in the solar collector panel over time and by at least occasionally reversing the air flow direction through the solar collector panel the heated air with the reduced relative humidity will be transported into the air drying means—thus, providing a simple and inexpensive way or regenerating the air drying means.

In an aspect of the invention, said air flow is reversed when the air drying quality of said air drying means has dropped below a predefined level.

It is advantageous to initiate the drying process of the air drying means when the efficiency of these has decreased below a certain level to ensure a proper quality of the exhausted air.

In an aspect of the invention, said reversed air flow is drawn in through a dedicated reversed flow air inlet.

Drawing at least some of the air in the reversed air flow from a dedicated reversed flow air inlet is advantageous in that it hereby is possible to process this air different from the air drawn through the normal air inlet and/or it is possible to draw the air from different locations.

In an aspect of the invention, said method is a method for operating a solar collector panel according to any of the previously mentioned solar collector panels.

### FIGURES

The invention will be described in the following with reference to the figures in which

FIG. 1 illustrates a first embodiment of a solar collector panel during normal operation, as seen from the side,

FIG. 2 illustrates the solar collector panel of FIG. 1 with a reversed air flow, as seen from the side,

FIG. 3 illustrates a second embodiment of a solar collector panel during normal operation, as seen from the side,

FIG. 4 illustrates the solar collector panel of FIG. 3 with a reversed air flow, as seen from the side, and

FIG. 5 illustrates a solar collector panel with a separate reversed flow air inlet, as seen from the side.

### DETAILED DESCRIPTION OF THE INVENTION

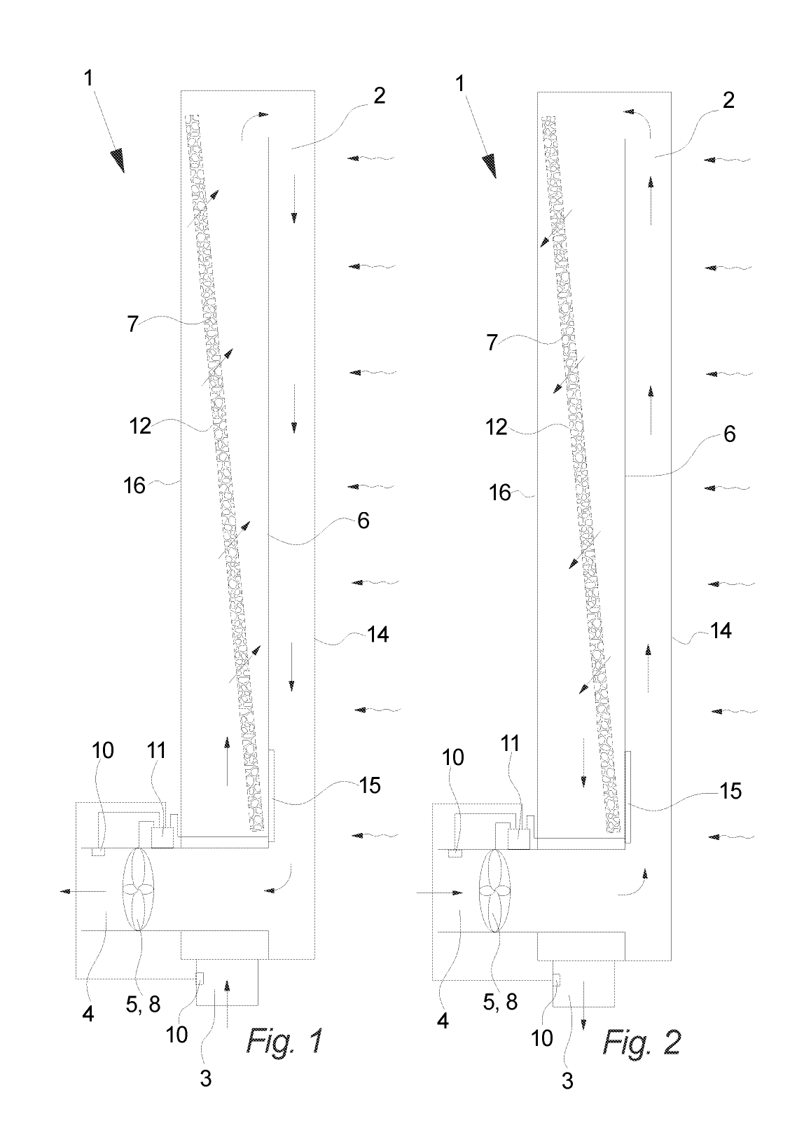

FIG. 1 illustrates a first embodiment of a solar collector panel during normal operation, as seen from the side.

In this embodiment the solar collector panel 1 comprises an air inlet 3 arranged at the bottom of the panel 1 and an air outlet 4 arranged at the back of the panel 1 so that if the panel 1 is mounted on a sloping roof surface or on the side of a building the heated air can be exhausted more or less directly into the building through the mounting surface at the back of the panel 1.

The present solar collector panel 1 is shown during normal operation where air flow means 5 in the form of a fan arranged at the air outlet 4 draws air into the panel 1 through the air inlet 3 and further through air drying means 7 to reduce the absolute humidity of the air. After the air drying means 7 the air continues down past the light absorbing means 6 which in this embodiment comprises a metal plate painted black. The light absorbing means 6 absorbs the radiation from the sun (illustrated by the curvy arrows) which will heat up the heat absorber plate 6. The large surface of the light absorbing means 6 ensures that this heat is efficiently dissipated to the passing air—thus heating the air before it is exhausted out through the air outlet 4.

To protect the inner components of the panel 1 and to increase the efficiency of the panel 1 the front plate 14 of the panel 1 is transparent or translucent. In this embodiment the front plate 14 is made from polycarbonate but in another embodiment it could be made from glass, another plastic material, a composite material or other.

In this embodiment the air flow means 5 is powered by a solar cell 15 having a photovoltaic side which is substantially orientated in the same direction as the front plate 14. However, in another embodiment the air flow means 5 could be powered by a battery, by an external power source or other.

In this embodiment the solar cell 15 is mounted on the outside of the front plate 14 but in another embodiment the solar cell 15 could be mounted on the inside of the front plate 14, on or at the light absorbing means 6 or anywhere else on, in or at the solar collector panel 1.

In all the embodiments disclosed in FIGS. 1-5 the air flow means 5 are in the form of a motor driven fan but in another embodiment the air flow means 5 could be a specific panel design utilizing a chimney-effect to create self-circulation or the air flow means 5 could be formed by a pump or other means suited for displacing air.

FIG. 2 illustrates the solar collector panel 1 of FIG. 1 with a reversed air flow, as seen from the side.

As the air drying means 7 absorbs moisture from the passing air the moisture absorbing property of the air drying means 7 is reduced so in this embodiment the panel 1 is provided with reversing means 8 in that the rotational direction of the air flow means 5 is changed (by control means 11), so that the air flow means 5 instead of drawing air out of the panel 1, pushes air into the panel 1 so that the air first is heated by the light absorbing means 6 before it passes through the air drying means 7. Hereby humidity from the air drying means 7 is released to the passing air and transported out into the surroundings. The air drying means 7 is thus regenerated and will now function efficiently again as a dehumidifier when normal operation is resumed.

In this embodiment the panel 1 is provided with a humidity sensor 10 arranged at the air inlet 3 and a humidity sensor 10 arranged at the air outlet 4. These humidity sensors 10 deliver data to control means 11—e.g. in the form of a small PLC, PC, logic circuit or other. The control means 11 will then control the operation of the air flow means 5 at least partly in response to output from these humidity sensors 10. In a preferred embodiment the humidity sensors 10 are supplement with temperature sensors (not shown) in that based on information of the humidity and temperature of both the incoming and the exhausted air it is possible to exactly calculate the absolute humidity of the incoming and the exhausted air. Thus, if these are compared a more or less exact status of the efficiency of the air drying means 7 can be derived.

The invention is e.g. particularly advantageous in relation with tropical climate zones with high humidity where it can be used for producing relatively dry air to prevent mould etc. in buildings and to dry crops and plants.

In the embodiments disclosed in FIGS. 1-4 the reversing means 8 are incorporated in the air flow means 5 but in another embodiment of the invention the reversing means 8 would be a separate fan—or another air flow generating device—arranged to generate an air flow in the opposite direction than the air flow means 5.

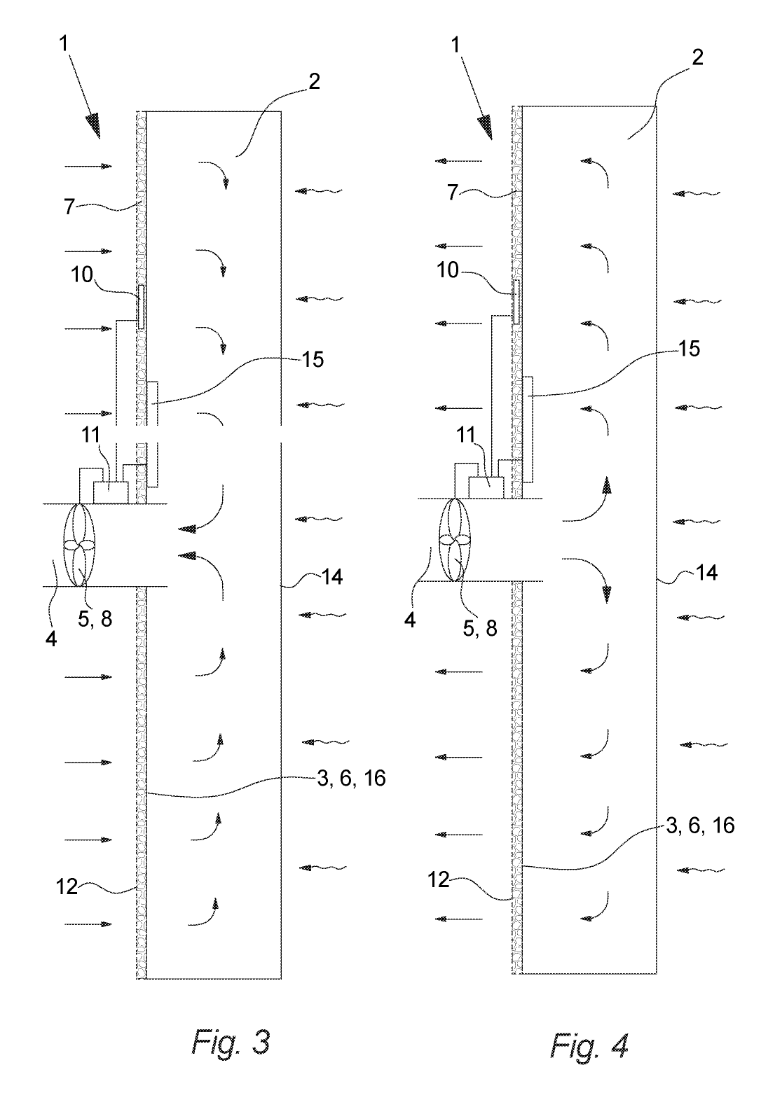

FIG. 3 illustrates a second embodiment of a solar collector panel 1 during normal operation, as seen from the side, and FIG. 4 illustrates the solar collector panel 1 of FIG. 3 with a reversed air flow, as seen from the side.

In this embodiment the panel 1 is provided with a perforated back plate 16 so that the air inlet 3 is distributed throughout this back plate 16 and in this embodiment the air drying means 7 is arranged outside this back plate 16 so that the air first have to pass through the air drying means 7 before it is drawn into the panel 1 to be heated by passing the light absorbing means 6 arranged on the inside of the back plate 16.

When the reversing means 8 is activated—as disclosed in FIG. 4—the air is first heated before it is pushed out through the perforated back plate 16 and further on through the air drying means 7.

Arranging the air drying means 7 at the back of the panel 1 is advantageous in that the air drying means 7 can be cooled by the surroundings and in that the air drying means 7 are easy to access.

In this embodiment the air drying means 7 are arranged in a separate container 12 which is detachably connected to the back plate 16 of solar collector panel 1 so that the air drying means 7 easily may be replaced, repaired or other. In this embodiment the separate container 12 is a box formed by wire mesh enabling that air can easily pass through the container 12. However, in another embodiment the air drying means 7 could be formed with a rigid—albeit porous—structure so that the container 12 could be avoided.

In this embodiment the air drying means 7 are silica gel (SiO2) but in another embodiment the air drying means 7 could instead or also comprise a number of other known desiccants and/or the air drying means 7 could also comprise additives or other to clean the air, to remove unwanted odour or other.

In this embodiment the solar panel 1 is provided with a humidity sensor 10 in direct contact with the air drying means 7 so that the operation of the air flow means 5 is controlled in response to a direct measurement of the humidity in the air drying means 7. This could e.g. be done by measuring the electrical resistance over a part of air drying means 7 or in a number of other ways.

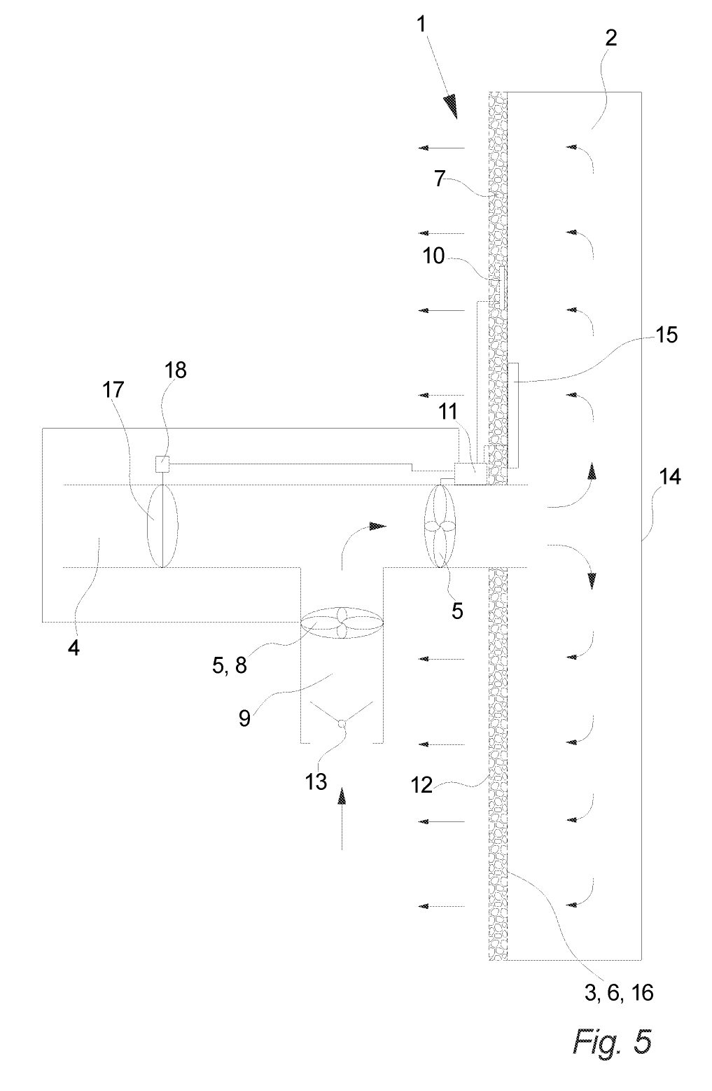

FIG. 5 illustrates a solar collector panel 1 with a separate reversed flow air inlet 9, as seen from the side.

In this embodiment the panel 1 further comprises a reversed flow air inlet 9 so that when the air flow direction through the panel 1 is reveres—to dry the air drying means 7—the air is drawn in through this dedicated reversed flow air inlet 9 instead of in through the air outlet 4.

Before the reversing means is activated—as they have been in FIG. 5—the air flow means 5 is first shut down before a valve 17 in the air outlet 4 is shut by means of a valve actuator 18. Separate reversing means 8—in this case in the form of a fan 5 located in the reversed flow air inlet 9—will now be activated whereby it will generate an air flow which will open a non-return valve 18 in the reversed flow air inlet 9 so that air is now drawn from the surrounding (through the reversed flow air inlet 9) instead of from the room to which the hot air is exhausted during normal operation of the panel 1.

All these operations are in this embodiment controlled by the control means 11 and powered by the solar cell 15.

In all the embodiments disclosed in FIGS. 1-5 the air drying means 7 are arranged in a shady part of the panel 1 i.e. at the back of the panel 1, behind the light absorbing means 6 or other. This is advantageous in that the moisture absorbing quality of desiccants is at least to some degree temperature dependent—i.e. the colder the desiccant is, the more moisture it can absorb.

FIGS. 1, 3, and 5 discloses different designs of the solar collector panel 1 capable of heating and moving air entirely by means of energy provided from the sun but in another embodiment the solar collector panel 1 could be designed differently it could comprise further and/or other components and/or the components could be arranged differently.

The invention has been exemplified above with reference to specific examples of designs and embodiments of solar collector panels 1, air flow means 5, air drying means 7 etc. However, it should be understood that the invention is not limited to the particular examples described above but may be designed and altered in a multitude of varieties within the scope of the invention as specified in the claims.

### LIST

1. Solar collector panel
2. Conduit
3. Air inlet
4. Air outlet
5. Air flow means
6. Light absorbing means
7. Air drying means
8. Reversing means
9. Reversed flow air inlet
10. Humidity sensor
11. Control means
12. Container for air drying means
13. Non-return valve
14. Front plate
15. Solar cell
16. Back plate
17. Valve
18. Valve actuator

1. A solar collector panel (1) configured for collecting thermal energy by heating of air, said solar collector panel (1) comprising
an air conduit (2) for guiding air through said panel (1) between an air inlet (3) and an air outlet (4),
air flow means (5) arranged to generate an air flow through said air conduit (2) from said air inlet (3) to said air outlet (4),
light absorbing means (6) arranged in or at said air conduit (2) to heat passing air, and
air drying means (7) arranged between said air inlet (3) and said light absorbing means (6) wherein said air drying means (7) is arranged to reduce the absolute humidity of passing air.

2. A solar collector panel (1) according to claim 1, wherein said air drying means (7) comprises a desiccant.

3. A solar collector panel (1) according to claim 1 or 2, wherein said solar collector panel (1) comprises reversing means (8) for at least occasionally reversing the air flow through said panel (1).

4. A solar collector panel (1) according to claim 3, wherein said reversing means (8) is at least a part of said air flow means (5).

5. A solar collector panel (1) according to claim 3 or 4, wherein said panel (1) further comprises a reversed flow air inlet (9) through which air is drawn when said air flow is reversed.

6. A solar collector panel (1) according to any of the preceding claims, wherein said panel (1) further comprises one or more humidity sensors (10).

7. A solar collector panel (1) according to claims 3 and 6, wherein said panel (1) comprises control means (11) arranged to activate said reversing means (8) on the basis of input from said one or more humidity sensors (10).

8. A solar collector panel (1) according to any of the preceding claims, wherein said air drying means (7) is arranged in a separate container (12) in or on said solar collector panel (1).

9. A solar collector panel (1) according to claim 8, wherein said separate container (12) is detachably connected to said solar collector panel (1).

10. A solar collector panel (1) according to any of the preceding claims, wherein said air drying means (7) further comprises air cleaning means.

11. A solar collector panel (1) according to any of the preceding claims, wherein said air inlet (3) is arranged separate from said air outlet (4).

12. A solar collector panel (1) according to any of the preceding claims, wherein said air drying means (7) are arranged between said air inlet (3) and said light absorbing means (6) inside said solar collector panel (1).

13. A solar collector panel (1) according to any of the preceding claims, wherein said air drying means (7) are arranged parallel with or at least substantially parallel with said light absorbing means (6).

14. A solar collector panel (1) according to any of the preceding claims, wherein the effective area of said air drying means (7) is equivalent to or at least substantially equivalent to the effective area of said light absorbing means (6).

15. A solar collector panel (1) according to any of the preceding claims, wherein said air drying means (7) extends substantially along the entire back plate (16) of said solar collector panel (1).

16. A solar collector panel (1) according to any of the preceding claims, wherein said solar collector panel (1) comprises a transparent or translucent front plate (14).

17. A method for operating a solar collector panel (1), said method comprising the steps of:
generating an air flow through air drying means (7) of said solar collector panel (1) to reduce the absolute humidity of the air passing through said air drying means (7), where after the air is led passed or through light absorbing means (6) to heat said air, and
at least occasionally reversing the air flow direction so that the air is first led by said light absorbing means (6) and then through said air drying means (7).

18. A method according to claim 17, wherein said air flow is reversed when the air drying quality of said air drying means (7) has dropped below a predefined level.

19. A method according to claim 17 or 18, wherein said reversed air flow is drawn in through a dedicated reversed flow air inlet (9).

20. A method according to any of claims 17-19, wherein said method is a method for operating a solar collector panel (1) according to any of claims 1-16.
